(19) United States
(12) Patent Application Publication
(10) Pub. No.: US 2002/0026817 A1
(43) Pub. Date: Mar. 7, 2002

(54) Quick lock mount

(75) Inventor: Dwight S. Greer, Molalla, OR (US)

Correspondence Address: KLARQUIST SPARKMAN, LLP, 121 SW SALMON STREET, SUITE 1600, PORTLAND, OR, 97204, US

(73) Assignee: Norment Security Group, Inc., a Delware Corporation Airteq Division

(21) Appl. No.: 09/877,796

(22) Filed: Jun. 7, 2001

Related U.S. Application Data
(60) Provisional application No. 60/211,697, filed on Jun. 14, 2000.

(51) Int. Cl. E05B 9/08

(52) U.S. Cl. 70/370

(57) ABSTRACT

An assembly and method for installing a cylinder lock. The assembly includes a mounting member having a defined opening therein, and an adapter having an internal bore adapted to receive the cylinder lock therein. The adapter has a plurality of outwardly extending projections and the mounting member has latch members adapted to inter-engage the projections. For installation, the adapter is oriented in a first position and inserted into the opening of the mounting member, and then is rotated to engage the prongs and latch members.

### CROSS REFERENCE

This application is based on provisional patent application no. 60/211,697, filed on Jun. 9, 2000. The entire disclosure of the provisional application is considered to be part of the disclosure of the following application and is hereby incorporated by reference herein.

### FIELD OF THE INVENTION

This invention relates to an assembly and method for installing a cylinder lock.

### BACKGROUND

The installation and mounting of key lock cylinders may be a difficult task. This is particularly so in the installation of such for locks in penal institutions, such as jails. Often jail closures require the use of thick-hardened metal plates, or members, which have an internally threaded bore into which a lock cylinder must be threaded. However, the hardened metal is difficult to machine fine threads into to receive a lock cylinder. Further, such lock cylinders often are installed by relatively unskilled parties who may try to force the threaded connections and cause cross threading or stripping.

Another potential problem is that key lock cylinders may have a cam, or actuator, mechanism, extending rearwardly therefrom which must be positioned to engage and actuate other mechanism within the lock system. In the past, where a worker has been required to screw the externally threaded key lock cylinder into a mounting member, there often has been a problem in properly positioning the rearwardly extending cam, or actuator, mechanism relative to mechanism to be actuated thereby. Explaining further, in past devices the rearwardly extending cam, or actuator, would be rotated as the lock cylinder was being threaded into place. Consequently, in the absence of adequate clearance (which could complicate the lock construction), the cam or actuator could hang up on or engage the mechanism to be actuated as the lock cylinder is being threaded into the system.

### SUMMARY OF THE DISCLOSURE

The present disclosure provides a system for installing a cylinder lock in which, in one form, an adapter comprises a body with an internal bore adapted to receive and hold a cylinder lock, with the adapter body comprising a plurality of outwardly extending projections, such as radially outwardly extending prongs. These prongs are typically spaced apart about a first outer section of the adapter. A mounting member into which the cylinder lock is to be installed has an opening therein, adapted to receive a section of the adapter having the prongs thereon. The mounting member is adapted to engage the prongs to retain the adapter in place against axial movement. In a specific form, the mounting member has latch members with spaces therebetween into which the adapter, with a cylinder lock held therein, may be inserted in a first orientation and then rotated to a second orientation, such that the prongs and latch members interengage. A retainer may also be used to prevent removal of the adapter and its associated cylinder lock.

With such assembly in the form having prongs and latch members as just described, it is a simple matter for the installer to assemble the adapter and cylinder lock into a single assembly, such that they are secured together, and then insert the adapter into the mounting member and rotate it as necessary (generally less than half of a revolution) to lock it into position.

In one specific form, the mounting member may comprise a formed cutout therein having inwardly directed edge margins providing latch members, and the adapter may have a configuration complementary to the cutout configuration, such that it may be inserted therein and rotated to lock the assembled adapter and lock cylinder in place in the mounting member.

The structure of the adapter and mounting member in certain forms are both able to be simply and inexpensively manufactured. For example, the mounting member may be a hardened metal plate which has a cutout of a selected configuration formed therein, as by laser cutting. The adapter may, for example, be a cast or machined part, having an internally threaded bore adapted to receive an externally threaded cylinder lock, and having outwardly extending projections thereon. Again, the projections may comprise prongs which are arrayed in a spaced apart relation about the periphery of the adapter and disposed in a substantially common plane.

Another aspect of the disclosure is a novel method for installing a lock, in which a cylinder lock is secured in an adapter and the combined adapter and cylinder lock are then inserted and secured in a mounting member through a twist-lock latch-engaging actuation.

The present invention is directed toward new and nonobvious features, method acts, and steps as described herein both individually and in various combinations and subcombinations thereof, as set forth in the claims below.

### DRAWINGS

FIG. 1 is a perspective rear view of one form of an assembly according to the disclosure, mounting a cylinder lock;

FIG. 2 is a perspective view similar to FIG. 1, with the cylinder lock and an adapter in which it is secured shown removed from a mounting member;

FIG. 3 is an exploded perspective view of the cylinder lock, adapter and mounting member of FIG. 2 prior to assembly;

FIG. 4 is a rear-end view of the assembly of FIG. 1 at an intermediate step in installation;

FIG. 5 is a rear-end view of the assembly of FIG. 1 fully installed; and

FIG. 6 is an enlarged cross-sectional view taken generally along the line 6-6 in FIG. 5.

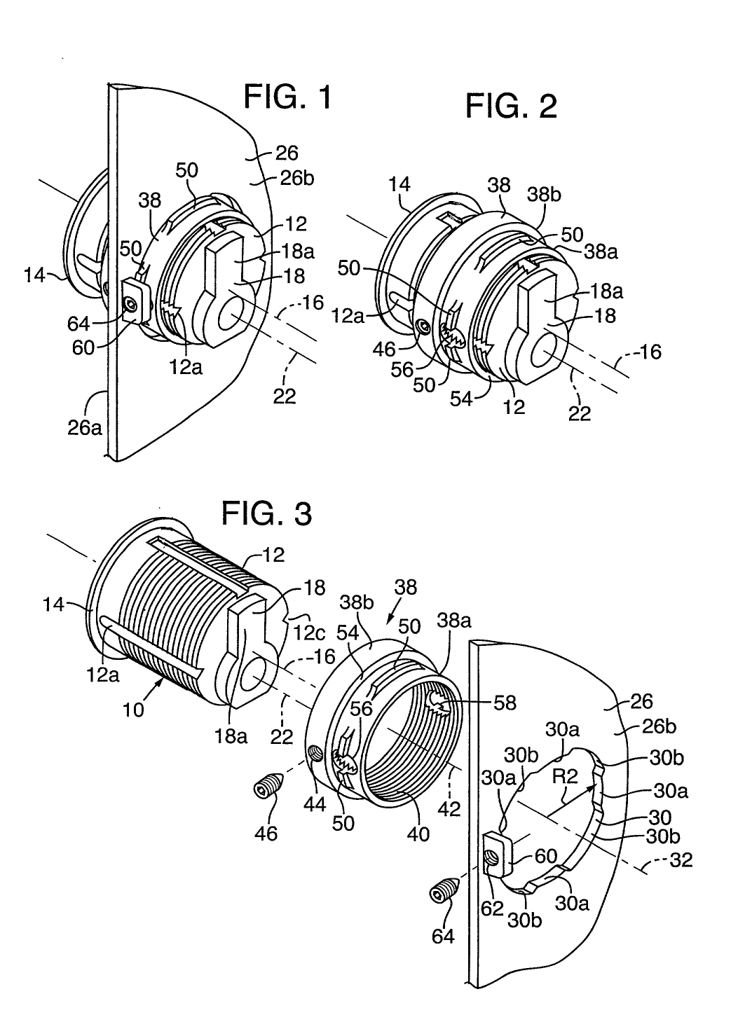

### DETAILED DESCRIPTION

Referring to FIG. 3, at 10 is indicated generally a key cylinder lock. The lock has an elongate, cylindrical body 12, which is externally threaded and has two elongate, longitudinally extending grooves spaced at 180 degrees relative to each other, these grooves being are indicated at 12a and 12c. The lock has a central longitudinal axis noted at 16. The forward, or outer, end of the lock has a face plate 14 which is of a larger diameter than body 12. Although not shown, face plate 14 would have an opening therein through which an operating key may be inserted.

At the rear end of cylinder body 12 is a rearwardly projecting actuating cam, or member, 18, having an upwardly projecting cam arm 18a. The cam is rotatable about a cam rotational axis 22, offset from axis 16.

The above described exemplary cylinder lock is conventional. The invention is not limited to any specific form of lock.

At 26 is indicated a heavy metal plate, or mounting member, into which cylinder lock 10 is to be mounted. As an example, member 26 may be a hardened steel plate forming a portion of a door in a prison or may be a part of a lock assembly in a frame adjacent a door. Additionally, a locking and latching mechanism (not shown) would be disposed adjacent plate 26 to be actuated by rotation of cam 18. Any suitable form of latching mechanism may be used. However, such is omitted for sake of clarity in these drawings. As a specific example, a locking mechanism may be used of the type disclosed in U.S. Pat. application Ser. No., attorney reference No. 2708-58546, entitled “Lock Assembly”, invented by Dwight S. Greer, filed the same day as the present application and incorporated by reference in its entirety herein.

The plate has a thickness indicated at “T” in FIG. 6. Although not required, the plate may be planar with substantially parallel front and back surfaces 26a, 26b, respectively. Other mounting members besides a plate may also be used to engage a lock receiving adapter.

As best seen in FIG. 3, the illustrated plate 26 has an opening 30 formed therein. This opening may be laser-cut or otherwise formed, and has a selected defined configuration. The central axis of opening 30 is indicated at 32. Opening 30 is formed with or comprises an adapter engagement structure or latch. This structure is designed to engage a lock receiving adapter without requiring multiple revolutions of the lock containing adapter to retain the adapter and received lock in place. In one desirable form, opening 30 comprises a plurality of first edge margin sections, or projections 30a, which are spaced a first distance from the center of the opening. Projections 30a extend inwardly toward the center of the opening. Projections 30a in the form shown are spaced apart about the periphery of opening 30, and, in the embodiment shown, are disposed at substantially 90 degrees relative to each other, although different spacing may be used for different circumstances, as desired. The projections may assume other configurations, or shapes, however, in the specific form shown they each comprise a generally trapezoidal shaped flange with an arcuate apex surface along a radius R₂. The flanges need not be the same shape.

Between the projections 30a are second edge margin sections 30b, which are spaced radially outwardly from the center 32 a second distance greater than the first distance R₂ for projections 30a. These second edge margin sections 30b define gaps or spaces between projections 30a.

The projections 30a thus comprise one form of latch members. The front surfaces of projections 30a may thus comprise a portion of front surface 26a of member 26 and rear surfaces of projections 30a may comprise a portion of the rear surface 26b of plate 26. As is seen in this embodiment, the rear surfaces of projections 30a are substantially co-planar with the rear surface 26b of remaining portions of plate member 26. Similarly, the front surfaces of projections 30a in this embodiment are substantially co-planar with the front surface 26 as of the remaining portions of plate member 26.

An adapter in the assembly in one form thereof is indicated generally at 38. The illustrated adapter is a ring-shaped member having a central threaded bore 40 of a size and with threads adapted to be screwed onto body 12 of lock 10. Adapter 38 may be screwed onto cylinder 12 to a selected position as illustrated in FIGS. 2 and 6. The adapter may provide a visual indication of the proper extent to which the cylinder is to be threaded into the adapter. For example, the adapter may have a depth such that the back surface of the cylinder is flush with the end of the adapter when the cylinder is in the desired position relative to the adapter to thereby visually indicate a desired relative positioning of these components. A central longitudinal axis of adapter 38 is indicated generally at 42. Other approaches may be used to couple or mount the lock to the adapter, for example, if the lock lacks external threads.

The adapter may include a first lock retainer to retain the lock and adapter together. The lock retainer may take any suitable form, such as a wedge or other construction. However, a desirable form of lock retainer comprises a set screw. To this end, a threaded side bore 44 extends through one side of adapter 38 to receive a set screw 46. When adapter 38 is screwed onto cylinder 12, set screw 46 may be screwed into side bore 44, with its inner end entering a groove, such as groove 12a, to prevent relative rotation between cylinder 12 and adapter 38, thus to secure the adapter 38 in a selected position on cylinder 12.

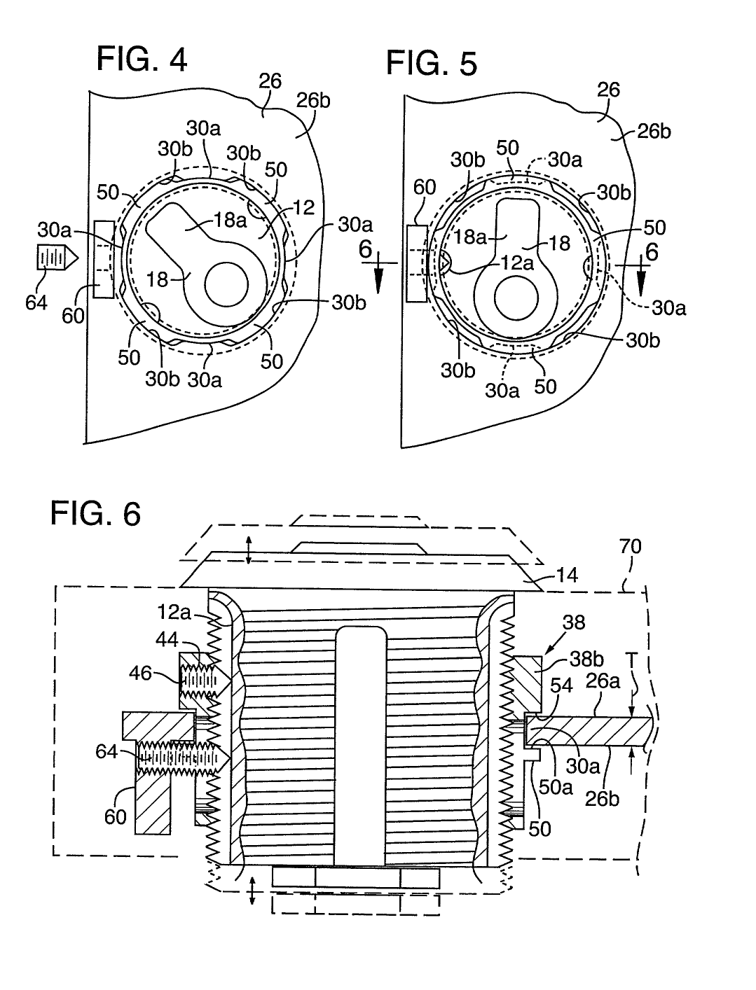

The illustrated form of adapter 38 has a first outer section 38a adjacent one end thereof, and a second outer section 38b adjacent the opposite end thereof. Section 38a is cylindrical throughout a major portion thereof having a radius (R₁) which is slightly less than the radial distance (R₂) to the innermost surfaces of projections 30a. Thus, the major portion of outer section 38a is configured to extend through opening 30. Although other forms may be used, the latch engagers may comprise a plurality of radially projecting prongs 50, which comprise one specific form of projections, extending radially outwardly from remainder portions of outer section 38a. In the illustrated embodiment, there are four prongs, which are spaced apart approximately 90 degrees from each other, with spaces or gaps therebetween. As can be visualized from FIG. 4, prongs 50 are positioned and configured to be inserted axially of the adapter through spaces 30b in opening 30, with projections 30a received in the spaces between prongs 50.

The prongs may be aligned in a substantially common plane perpendicular to axis 42 about the periphery of section 38a of adapter 38. The prongs may comprise trapezoidal shaped flanges with arcuate outer edges with a radius in excess of radius R₂. Although not required, the flanges may each be the same size and shape with parallel front and rear surfaces. The prongs shown have front faces 50a (FIGS. 2, 6), which face toward outer section 38b thereof (FIG. 6).

As is possibly best illustrated in FIGS. 4 and 5, section 38a and prongs 50 of adapter 38 have a generally complementary configuration to opening 30 in plate member 26. As shown in FIG. 4, when the adapter 38 is in a first orientation, prongs 50 are positioned to move through spaces 30b, with the spaces between prongs 50 receiving projections 30a. In this first orientation, the adapter, with its associated lock cylinder, may be inserted longitudinally into opening 30. When the adapter 38 then is rotated (in a clockwise direction as illustrated in FIGS. 4 and 5) to the position illustrated in FIG. 5, prongs 50 move into position adjacent the rear sides of projections 30a to prevent removal of the adapter and lock in an axial direction.

Referring to FIGS. 3 and 6, outer section 38b may comprise a collar having a radius greater than dimension R₂ of opening 30 to act as one form of a stop element, such that when section 38a of the adapter is inserted through opening 30, the rear face, or surface, 54 of section 38b engages front face 26a of plate member 26 to prevent the adapter 38 from moving fully through opening 30. Other forms of projecting stops may be used as alternatives to the annular collar surface 54. With the adapter 38 in the position illustrated in FIGS. 5 and 6, surface 54 of outer section 38b prevents movement of the adapter through plate 26 in one axial direction, and prongs 50, being latched behind the rear surfaces of projections 30a, prevent removal, or movement in the opposite axial direction.

This latching of adapter 38 into plate member 26 is accomplished merely by inserting the adapter and its associated cylinder lock into opening 30 in a first orientation, as illustrated in FIG. 4, and rotating it to a second orientation, as illustrated in FIG. 5, with the rotation desirably being less than 90 degrees, and in this instance approximately 45 degrees. It should be recognized that, with differing numbers of prongs 50 and projections 30a from those illustrated in this embodiment, differing angular rotation requirements would be achieved.

The distance between front face 50a of the prongs and rear face 54 of the collar portion of outer section 38b may be slightly greater than thickness “T” of plate member 26, as best illustrated in FIG. 6.

A second lock adapter assembly retainer may be employed to retain the installed adapter lock assembly in place. In one form, this second retainer is designed to restrict angular rotation of the assembly such that the engaged prongs and projections do not rotate to disengaged positions. Adapter 38 may have a pair of opposed openings 56, 58 extending through opposite sides thereof. These openings may be elongated in the axial direction and may be oval. Plate member 26 may comprise a set screw receiver, such as a tab 60 secured thereto, as by welding, adjacent one side of opening 30. A threaded bore 62 extends through tab 60.

As best seen in FIG. 6, after the adapter and lock assembly have been positioned as desired in FIGS. 5 and 6, a set screw 64 may be screwed through tab 62, through one of openings 56, 58, and into an elongate groove such as 12a in a side of cylinder 12 to lock the lock-adapter assembly in position in plate member 26.

Describing operation of the illustrated assembly, a lock cylinder 12 is screwed into adapter 38 to a selected position longitudinally of the adapter. The extent to which the cylinder is screwed into the adapter may be determined by the position desired for face plate 14 relative to a facing plate for the lock assembly, such as that indicated generally in dashed outline at 70 in FIG. 6. After the adapter and cylinder have been screwed together to the extent desired, set screw 46 is extended through bore 44 and into one of the elongate groove, such as groove 12a, on the cylinder.

After the cylinder and adapter thus have been coupled to each other, it is a simple matter to insert the cylinder and adapter assembly longitudinally through opening 30 in plate member 26, with the adapter and cylinder in a first orientation, as illustrated in FIG. 4, with prongs 50 passing through spaces 30b, and the spaces between prongs 50 receiving projections 30a of opening 30. The adapter is pressed toward plate member 26 until rear face 54 of outer section 38b of the adapter engages the front face 26a of plate member 26. The adapter and cylinder assembly then is rotated to the second orientation, as illustrated in FIG. 5, such that prongs 50 come into alignment with projections 30a to latch the adapter and cylinder in place. Once the adapter and cylinder are thus latched into place, set screw 64 is screwed through bore 62 to extend through one of openings 56, 58 and into an elongate groove such as that indicated at 12a.

As will be seen, this assembly allows a relatively unskilled worker to screw the adapter onto the cylinder lock, secure it in an appropriate position, and then, without the requirement of fine positioning, insert the bayonet mount style adapter 38 through opening 30 in a first orientation and then rotate it to a second orientation to lock the cylinder in an appropriate position.

Not only does this permit ease of assembly and installation, but also allows such lock mechanism to be easily installed in applications where an actuation mechanism is positioned closely adjacent the back of the lock where cam 18 otherwise may impinge upon the actuation mechanism if it were rotated through numerous rotations.

While exemplary embodiments have been described herein, it should be apparent to those skilled in the art that variations and modifications are possible without departing from the spirit of the invention. I claim as my invention all such modifications as fall within the spirit and scope of the following claims.

I claim:

1. An assembly for installing a cylinder lock comprising:
an adapter comprising a body with an internal bore adapted to receive a cylinder lock therein, the body comprising a first section and a plurality of projections extending outwardly of the first section of the body; and
a mounting member having an opening therein adapted to receive the first section of the body when the first section of the body is inserted through the opening in a first direction, the opening defining spaces configured to permit passage of the projections through the spaces when the adapter is positioned in a first orientation and the first section of the body is inserted through the opening, the mounting member comprising a plurality of latch members adapted to engage the projections to prevent removal of the adapter in a second direction opposite to the first direction upon rotating the adapter from the first orientation to a second orientation.

2. The assembly of claim 1 in which the body further comprises a stop spaced from the projections and operable to engage a portion of the mounting member to thereby limit the extent of insertion of the first body section in the first direction into the opening.

3. The assembly of claim 2 wherein the latch members respectively have rear surfaces facing in the first direction which engage the projections and wherein said stop comprises an annular collar which is operable to engage a portion of said mounting member which faces in the second direction to limit the extent of insertion.

4. The assembly of claim 1 wherein the mounting member comprises a plate element having a selected thickness and front and rear plate surfaces, the latch members being formed from a portion of the plate member and having respective projection engaging rear surfaces which are substantially co-planar with the rear plate surface of remainder portions of the plate member, and wherein the stop is spaced from the projections a distance which is slightly greater than the selected thickness, the projections comprising a plurality of radially extending prongs having latch member engaging surfaces positioned to engage the respective prong engaging rear surfaces and wherein the stop faces a portion of the front plate surface upon rotation of the adapter to the second orientation.

5. The assembly of claim 4 wherein the opening comprises a cut-out in said plate member and the latch members comprise first edge margin portions of the cut-out which project radially inwardly toward the center of the cut-out.

6. The assembly of claim 5 wherein the latch members are generally trapezoidal in shape.

7. The assembly of claim 1 wherein said opening and latch members are of a first configuration and wherein said first body section and projections are of a second configuration which is complementary to the first configuration.

8. The assembly of claim 1 wherein the body has a longitudinal axis and wherein the projections comprise flanges aligned in a substantially common plane and which extend outwardly in a direction which is perpendicular to the longitudinal axis of the body, the flanges being positioned about the periphery of the first section of the body.

9. The assembly of claim 1 wherein the projections and latch members are so positioned on their respective adapter and mounting member that said projections interengage with said latch members to prevent removal of the adapter in the second direction upon rotation of the adapter from the first orientation through no more than about 90 degrees to the second orientation.

10. The assembly of claim 1 wherein the projections and latch members are so positioned on their respective adapter and mounting member that the projections interengage with the latch members to prevent removal of the adapter in the second direction upon rotation of the adapter from the first orientation through no more than about 45 degrees to the second orientation.

11. The assembly of claim 1 wherein the bore is internally threaded so as to receive an externally threaded cylinder lock which is screwed into the bore, the position of the cylinder lock relative to the adapter being determined by the extent to which the cylinder lock is screwed into the bore.

12. The assembly of claim 11 further comprising a first retainer coupled to the adapter and lock and operable to retain the lock in a selected position to which it has been threaded into the adapter.

13. The assembly of claim 12 including a second retainer adapted to selectively couple the adapter to the mounting member to prevent rotation of the adapter from the second orientation to the first orientation.

14. An assembly for installing a cylinder lock comprising:
an adapter adapted for coupling to a cylinder lock;
the adapter comprising at least one latch engager;
an adapter mount comprising at least one latch member;
the latch engager and latch member being configured to engage one another to retain the adapter in position on the adapter mount without requiring the adapter to be rotated through more than 90 degrees to accomplish the engagement of the latch and latch member.

15. An assembly for installing a cylinder lock comprising:
an adapter comprising a body with an internal bore adapted to receive a cylinder lock therein, the body comprising a first section and at least one projection extending outwardly of the first section of the body; and
a mounting member having an opening therein adapted to receive the first section of the body when the first section of the body is inserted in a first direction through the opening; and
at least one latch member coupled to the mounting member and adapted to engage said at least one projection to prevent removal of the adapter in a second direction opposite to the first direction upon engagement of the at least one projection with the at least one latch member.

16. The assembly of claim 15 further comprising a first securing mechanism adapted to selectively secure the cylinder lock to the adapter.

17. The assembly of claim 16 which further comprises a second securing mechanism adapted to selectively secure the adapter to the mounting member.

18. The assembly of claim 16 wherein the internal bore is threaded so as to threadedly receive the cylinder lock, the adapter body further comprising at least one set screw receiving threaded bore extending through a side of the body and wherein the first securing mechanism comprises a set screw extending through the set screw receiving threaded bore and into engagement with the cylinder lock to prevent relative movement of the cylinder lock and adapter body, the adapter body comprising at least one set screw receiving adapter body opening extending through the first section of the body, the mounting member comprising at least one threaded second bore, the second securing mechanism comprising a second set screw threaded through the second bore and extending through the adapter body opening to secure the adapter body and mounting member against relative movement.

19. The assembly of claim 18 wherein the adapter body has a longitudinal axis and wherein the adapter body opening is elongated in the direction of the longitudinal axis of the adapter.

20. In an assembly for installing a cylinder lock, an adapter comprising:
an adapter body having a central axis and an internal bore extending in the direction of the central axis, the internal bore being threaded;
the adapter body comprising a first section having an outer end, the adapter comprising a plurality of latch engaging projections extending outwardly from the first section;
the adapter comprising at least one stop projecting outwardly at a location spaced from the projections and on the opposite side of the projections from the outer end of the adapter, the stop comprising an annular collar portion of the adapter;
the projections comprising a plurality of flanges spaced apart from one another and located in a common plate extending generally transversely to the central axis of the adapter;
at least one threaded set screw receiving bore extending through the collar portion of the adapter; and
at least one opening which is elongated in the direction of the central axis and which extends through the first section of the body.

21. An assembly for installing a cylinder lock comprising:
a mounting member comprising an opening therein with a plurality of first projections extending radially into said opening, with first spaces between said first projections, said first projections being disposed in a substantially common plane and having back surfaces, and
an adapter comprising a central axis and an internal bore adapted to receive a cylinder lock therein, a first outer section having a plurality of second projections extending radially outwardly therefrom with spaces therebetween, said second projections having front surfaces and said second projections being positioned to pass through said first spaces in said opening when said adapter is disposed in a first orientation, said second projections being adapted to engage the back surfaces of said first projections to inhibit removal of said adapter from said opening when the adapter is rotated about its central axis from said first orientation to a second orientation.

22. The assembly of claim 21, wherein said back surfaces of the first projections face in one direction and said mounting member has a front surface facing in the opposite direction, and said adapter comprises a stop positioned to engage said front surface to prevent insertion of said adapter into said mounting member beyond a selected position.

23. The assembly of claim 22, wherein said mounting member comprises a plate element having a selected thickness, said first projections are formed from a part of said plate member and their back surfaces are substantially co-planar with a rear side surface of remainder portions of said plate member, and wherein the stop is spaced from said second projections a distance slightly greater than said selected thickness to engage a front side surface of said plate member opposite said rear side surface.

24. The assembly of claim 21, wherein said second projections comprises flanges aligned in a substantially common plane about the periphery of the adapter.

25. The assembly of claim 21, wherein said first and second projections are so positioned such that said first and second projections inter-engage to prevent removal of the adapter from the mounting member upon rotation of the adapter from said first orientation to said second orientation through an angle of rotation which is no greater than 90 degrees.

26. The assembly of claim 21, wherein said first and second projections are so positioned that said first and second projections inter-engage to prevent removal of the adapter from the mounting member upon rotation of the adapter from said first orientation to said second orientation through an angle of rotation which is no greater than about 45 degrees.

27. The assembly of claim 21, which further comprises a first retainer operable to secure said cylinder lock in said adapter.

28. The assembly of claim 27, which further comprises a second retainer operable to secure said adapter against rotation from its second to its first orientation after it has been positioned on said mounting member.

29. The assembly of claim 21, wherein said bore is internally threaded to be screwed onto an externally threaded cylinder lock with the position of the cylinder lock relative to the adapter determined by the extent to which they are screwed together.

30. An assembly for installing a cylinder lock comprising:
a mounting plate having front and back surfaces and a first opening extending therethrough between said front and back surfaces, the first opening being of a selected configuration with first edge margin sections spaced a first distance from the center of the opening and second edge margin sections between said first edge margin sections spaced outwardly from the center of the opening a second distance greater than said first distance; and
an adapter having a central axis and an internal bore adapted to receive a cylinder lock therein, a first outer section having a configuration adapted to pass in one direction through said first opening when the adapter is disposed in one orientation and comprising projections thereon adapted to engage said first edge margin sections on the back surface of the mounting plate when the adapter is rotated about its central axis from said one orientation to a second orientation to inhibit removal of said adapter from said plate, and a stop on a second outer section of said adapter spaced from said projections to prevent portions of said adapter other than said first section from passing through said first opening in said one direction.

31. The assembly of claim 30, wherein said mounting plate has a selected thickness and said stop element is spaced from said projections a distance greater than said selected thickness.

32. The assembly of claim 30, wherein said the bore of said adapter is internally threaded to receive and hold an externally threaded cylinder lock therein.

33. The assembly of claim 30, wherein a plurality of said first edge margin sections are disposed in spaced apart relation about the periphery of said first opening with a plurality of spaces therebetween in the regions of said second edge margin sections, and said adapter comprising a plurality of said projections positioned to pass through said spaces in the regions of said second edge margin sections when the adapter is in said one orientation with spaces between said projections adapted to receive said first edge margin portions.

34. An assembly for installing a cylinder lock comprising:
adapter means for receiving the cylinder lock; and
mounting means coupled to the adapter means for supporting the adapter means and received cylinder lock.

35. A method of installing a cylinder lock comprising the acts of:
providing an adapter having an internal bore adapted to receive a cylinder lock and having at least one outwardly extending projection on an outer section thereof, and a mounting member comprising an opening adapted to receive the outer section of the adapter and at least one latch member adapted to interengage said at least one projection;
mounting said cylinder lock in the internal bore of the adapter, inserting the adapter into said opening in a first orientation with the at least one projection passing through the opening; and
rotating the adapter to a second orientation to engage the at least one projection and at least one latch member to hold the adapter on the mounting member.

36. The method of claim 35, wherein said adapter is inserted from one face side of the mounting member and including the act of positively limiting the extent to which the adapter may be inserted.

37. The method of claim 35, which further comprises the act of securing the cylinder lock in the adapter.

38. The method of claim 35, wherein, following rotation of the adapter to said second orientation, the method comprises the act of securing the adapter against rotation from said second orientation.

39. The method of claim 35, wherein said rotation from said first to said second orientation is a minor part of a circular arc which is no greater than 90.
